(19) United States
(12) Patent Application Publication
(10) Pub. No.: US 2007/0240214 A1
(43) Pub. Date: Oct. 11, 2007

(54) Live routing

(76) Inventor: Andrea Nicole Berry, Alexandria, VA (US)

Correspondence Address: Andrea Nicole Berry, # 1-D, 905 Gibbon Street, Alexandria, VA, 22314-4079, US

(21) Appl. No.: 11/392,801

(22) Filed: Mar. 30, 2006

(51) Int. Cl. G06F 12/14

(52) U.S. Cl. 726/22

(57) ABSTRACT

Live Routing is a network security device that protects computer systems at the source code level of network communications. This device monitors, scans, records, reports and deletes intruder codes before they enter a network. Live Routing also provides an internal audio/visual recording system to monitor employee activity.

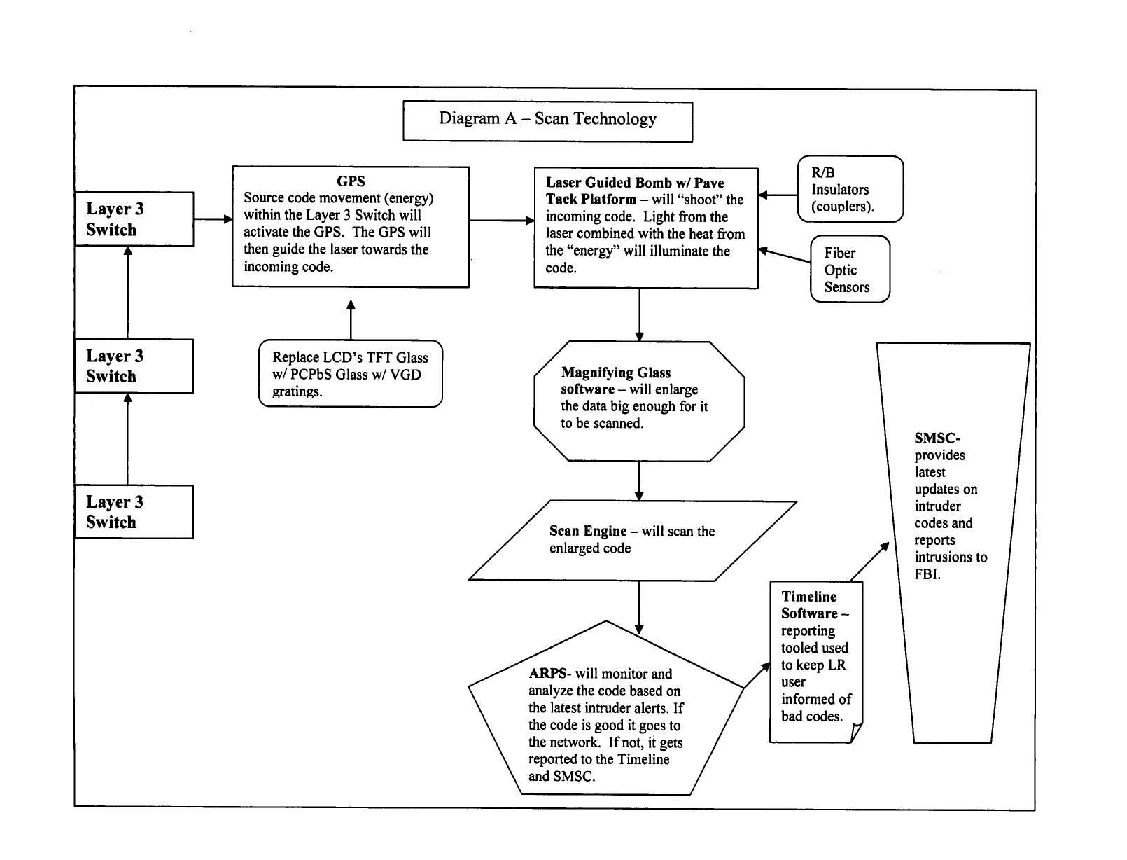

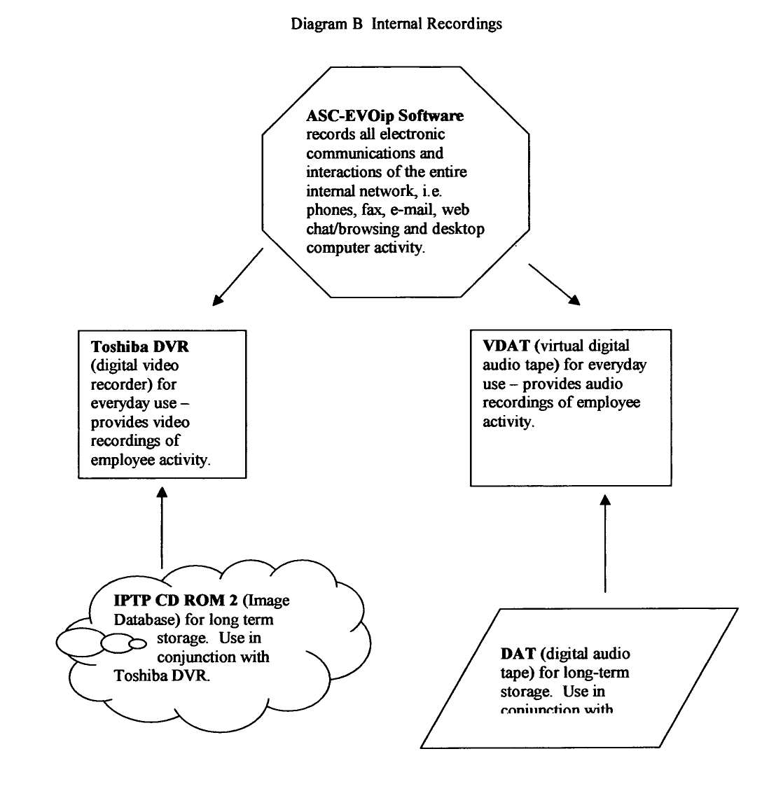

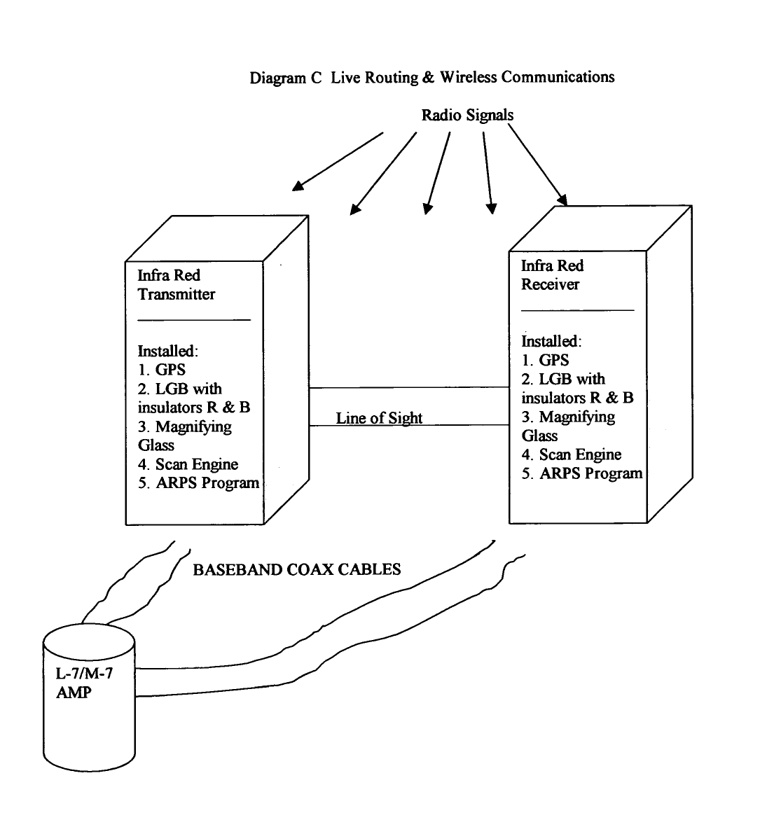

### BACKGROUND OF THE INVENTION

1. Field of Invention

US 2001/0001111 A1

2. Description of Related Art

Network/Internet Security measures that help protect private networks and individual computers from cyber-attacks. They include antivirus software, security packs, and passwords. Some of our more secure security measures include encryption, authorization and authentication.

### SUMMARY OF THE INVENTION

Live Routing is a unique combination of technology, taken from a variety of industries, and put together in a way that will expose, enlarge, scan, report and subsequently delete the actual “data packets” or computer codes that are sent throughout the networks. It also records and monitors every interaction and communication of the entire network including website, chat room and telephone usage.

### BRIEF DESCRIPTION OF THE DRAWINGS

Diagram A Scan Technology is the step-by-step process in which Live Routing will enhance codes sent from one computer system to another in order to track and dispose of bad code. It also shows the details of how the communication between the network and Short Message Service Center (virus patrol) takes place in order to send and receive intruder information and “live” updates. Diagram B Internal Recordings describes the recording aspects of Live Routing and the proper way to connect the technology. Diagram C Live Routing and Wireless Communications explains how Live Routing's Scan Technology works with wireless connections.

### SPECIFICATIONS

The following is the step-by step setup process for the Live Routing concept. First, take what is called a CAC 6500 Remote Terminal Unit, which is normally used in the oil industry. It will need to have its usual four 3-mode (PID) controller loops to produce calculations and display output every second. It should also have its usual communication interface software: MODBUS ASCII, MODBUS RTU or CAC 8500. Next, add an accelerated graphics port (AGP), video adapter, and a graphics accelerator with a 128-bit register width. The accelerated graphics port (AGP) eliminates bottlenecks in the system by implementing three methods called Dedicated Ports, Pipelining and Sideband Addressing. Dedicated Ports are ports with nothing connected to them but graphics cards. Pipelining allows the graphic card to receive and respond to multiple packets of data in a single request. Sideband Addressing creates eight additional lines on the data packet for addressing. These eight additional lines also frees up the total bandwidth of the data path used to transfer information back and forth.

Next, add Windows XP operating system with an “.xpx” file extension. This file extension is a MIME: a Multipurpose Internet Mail Extension. In other words, it's a protocol widely used on the Internet that extends the SMTP (Simple Mail Transfer Protocol) to permit data, such as video, sound and binary files, to be transmitted by e-mail without having to be translated into ASCII format first.

There are other key programs and component to be installed and implemented. These include:
1. RVS-COM/ADSL—a tool that provides multiple functionalities which allows the user to utilize his/her Internet bandwidth to the fullest. RVS-COM/ADSL helps monitor the Internet connection status and repairs any connection that has been disconnected. The upload and download times can be improved by using various RVS-COM features. Functionalities include PPPoE driver, software router, traffic shaping, firewall, “always on” status provides multiple functionalities, diagnostic tool, budget, and DSL controller.
2. YouPerform—an e-mail enhancer for Microsoft's Outlook that allows users to cut through massive emails and speed up its efficiency. YouPerform offers 15 tools that make Outlook trouble free by eliminating duplicate e-mails, saves space by automatically saving attachments to folder defined and sends addresses straight to the Address Book.
3. Instant Messaging—a type of communications service that enables you to create a private chat room with another individual in order to communicate in real time over the Internet. IM is similar to a telephone conversation but uses text-based, not voice-based communication. Typically, the instant messaging system alerts the user whenever somebody on his/her private list is online. The user can then initiate a chat session with that particular individual.
4. Short Message Service (SMS)—The transmission of short text messages to and from a mobile phone, fax machine and/or an IP address. Messages must be no longer than 160 alphanumeric characters and contain no images or graphics. (Use in conjunction with Short Message Service Center (SMSC).
5. Data Management and Interchange standards (JTC1 SC 32)—The control of data from acquisition and input through processing, output, and storage. In microcomputers, hardware manages data by gathering it, moving it, and following instructions to process it. The operating system manages the hardware and ensures that the parts of the system work in harmony so that data is stored safely and accurately. Application programs manage data by receiving and processing input according to the user's commands and sending results to an output device or to disk storage. The user is also responsible for data management by acquiring data, labeling and organizing disks, backing up data, archiving files, and removing unneeded material from the had disk
6. IPW Database—a high-resolution, 400-dpi, 8-bit, image database that scans, reads and digitizes handwritten samples.
7. Protocols—
   a. TCP/IP v.4 and v.6—protocol suites developed by the U.S. Department of Defense for communications over interconnected, sometimes dissimilar, networks. They are built into the UNIX system and have become the de facto standard for data transmission over networks, including the Internet.”
   b. HTTP—the protocol used to carry requests from a browser to a Web server and to transport pages from Web servers back to requesting browser. Although HTTP is almost universally used on the Web, it is not an especially secure protocol.
   c. SMTP—A TCP/IP protocol for sending messages from one computer to another on a network. This protocol is used on the Internet to route e-mail.
   d. POP3—the current version of the Post Office Protocol standard in common used on TCP/IP networks.
   e. FTP—a fast application-level protocol widely used for copying files to and from remote computer systems on a network using TCP/IP like the Internet. This protocol also allows users to use FTP commands to work with files, like listing files and directories on the remote system.
   f. NNTP—A de facto protocol standard on the Internet used to distribute news articles and query news servers.
   g. UDP—the connectionless protocol within TCP/IP that corresponds to the transport layer in the ISO/OSI reference model. UDP converts data messages generated by an application into packets to be sent via IP but it is unreliable because it does not establish a path between sender and receiver before transmitting and does not verify that messages have been delivered correctly. UDP is more efficient that TCP so it is used for various purposes including SNMP; the reliability depends on the application that generated the message.
   h. SNMP—The network management protocol of TCP/IP. In SNMP, agents, which can be hardware as well as software, monitor the activity in the various devices on the network and report to the network console workstation. Control information about each device is maintained in a structure known as a management information block.
   i. USPC—is the “client” program of the Universal Profiling Schema (UPS) server. It is used as a quick way to poll the status of an UPS server. It can be used inside shell scripts and other programs that need UPS data but not the full interface. The Universal Profiling Schema is defined as a universal model that provides a detailed description framework for different contexts. The UPSC is the program that will extract relevant information about the mobile devices described by the profiles and perform all the operations related to searching, making statistical studies and transforming the profiles.
8 Mirroring Software/Setup—in mirroring both the client and the server have the exact same software components, functionalities, jobs and features. They mirror each other exactly in case one breaks down or slows down, the other can pick up the workload. In this case, the PCP terminal will be mirrored with the storage server.
9. 2 Java programs—an object oriented programming language developed by Sun Microsystems, Inc. Similar to C++, Java is smaller, more portable, and easier to use than C++ because it is more robust and it manages memory on its own. Java was also designed to be secure and platform-neutral. The 2 Java programs are needed to replicate the ARPS weather predicator and analyzer system and the RF-4C Laser Guided Bombs platform. (Needed only if the ARPS and RF-4C Laser Guided Bombs programs are unobtainable.)

There are CASE Tools should be used to created two Java programs. They are as follows:
1. Computer-Aided Design (CAD)—A system of programs and workstations used in designing and engineering architectural and scientific models ranging from simple tools to buildings, aircraft, integrated circuits and molecules. Various CAD applications create objects in two or three dimensions, presenting the results as wire-frame skeleton, as more substantial models with shaded surfaces, or as solid object. Some programs can also rotate or resize models, show interior views, generate lists of materials required for construction, and perform other allied functions. CAD programs rely on mathematics, often requiring the computing power of a high-performance workstation
2. REGEX Coach—graphical programming aid that allows the user to experiment with Perl compatible regular expressions interactively.

Once the remote terminal is fully loaded it will be used as a “holding pod”. The terminal will be connected to a scanning setup that will deposit modified data packets in it. It will then be used to send and receive code and updates.

Next, a unique scanning system will be created. The items needed for the scanning system are listed and explained in the following:
1. Network Time Server (NTS) with Telnet—both hardware and software components are used to keep computer clocks on time and in sync.
2. Scan Engine ONLY—a scan engine is the most important part of antivirus software: it does the actual work of scanning files and detecting viruses. Scan engines are graded based on their scanning speed and number of successful detection performance.
3. Smart Weapons Lasing System—a government created platform that is used in conjunction with Smart Weapons. It consists of a digital aviation computer system with automated laser bombs installed. These bombs are called “laser-guided bombs” because they are self-lasing, tracking and designating. “The pods use an imaging infrared sensor and designator/ranger for navigational updates, target acquisition and recognition. It contains an electro-optical laser system for precision tracking and an infrared detector for designating its target. The most important parts of the Smart Weapons technology needed for the scanning setup are:
   a. Fiber-Optical Sensors—A technology for the transmission of light beams along both optical fibers and electronic circuitry. A light beam, such as that produced in a laser, can be modulated to carry information. Because light has a higher frequency on the electromagnetic spectrum than other types of radiation, like radio waves, a single fiber-optic channel can carry significantly more information than most other means of information transmission.
   b. PCPbS glass with Variable Groove Depth (VGD)—a glass window that fiber-optic sensors use to manage light. This window will need to have Variable Groove Depth gratings. Variable Groove Depth (VGD) gratings are large amounts of “cuts” or gratings strategically placed in glass to diffract or bend light. Both the PCPbS and the VGD gratings are normally used in spectroscopy.
4. Timeline Software—a program that tracks and creates visual graphics of schedules of planned events in a program or project.
5. Novell Netware (IPX)—A family of LAN operating system products developed by Novell, Inc. Designed to run on PCs and Macintoshes, Netware allows users to share files and system resources such as hard disks and printers. In this project, Netware is needed for its Internet Packet Exchange feature.
6. Insulators R and B—thermo-couplers used in heat-treating, sensor control, glass manufacturing, ferrous and non-ferrous metals. These insulators will be used in conjunction with the laser technology mentioned earlier.
7. Global Positioning System (GPS)—A radio navigation system developed by the U.S. Department of Defense that uses a constellation of 24 earth satellites, which are monitored by ground-based control stations, to provide precise, continuous worldwide positioning and timing information. Also needed is the Precise GPS Satellite Orbits, created by NOAA that uses 24-hour data segments from the global GPS network. Replace the Global Positioning System's LCD's TFT Glass w/ PCPbS Glass w/ VGD gratings.
8. Advanced Regional Prediction System (ARPS)—a weather system that monitors and analyzes weather patterns and forecasts or predicts what type of weather patterns are to come based on past trends.
9. Magnifying Glass Software—relatively new software that enlarges objects on the computer monitor for people who have problems with their vision.
10. (3) Layer 3 Switches—are bridges with routers inside. A bridge is “a device that connects networks using the same communications protocols so that information can be passed from one to the other. It can also be used to connect two LANs whether or not they use the same protocols, allows information to flow between them. The bridge operates at the ISO/OSI data-link layer.” These will be used to transfer data packets as well as activate the GPS
11. Short Message Service Center—a replace to send and receive “intruder” information including virus updates, hacker warnings and to report intruder infections. (Use in conjunction with Short Message Service software)
   See Diagram A: Scan Technology.
      Diagram A displays the basic concepts of Live Routing's Scan Technology. This is a bird's eye view of what's happening inside Network Time Server. There are 3 Layer 3 Switches (L3S) connected to the Network Time Server (NTS). NTS is already loaded with technology to keep time and synchronization of the network's computer clocks. (This technology will be used in conjunction with the Global Position System).

There should be 3 Layer 3 Switches placed strategically between the network, Live Routing creation and Internet connection. The “energy” from the layer 3 switches will activate the GPS much like wireless technology works today. The GPS senses this energy, activates and then tells the Laser System where the energy is coming from.

The laser will in turn “shoot” the energy. The light from the laser combined with the heat from the energy will cause the “data packet” code to appear, but not to the naked eye. The magnifying glass will enlarge the code enough for the scan engine to scan it. The ARPS software on the remote terminal will receive this enhanced code and check it against the intruder information in its database. If the code is good the ARPS will send it on to the network. However, if the code is bad, the ARPS will send the code to the “virus patrol” and promptly send the information to the Timeline Scheduler. Timeline will document the information and the ARPS will delete the bad code.

In order to grasp exactly how the ARPS system will send bad code and receive live updates the components of this transaction must be discussed. The necessary items are:
1. Mirroring Software/Setup—in mirroring both the client and the server have the exact same components, functionalities, jobs and features as the other. They mirror each other exactly in case one breaks down or slows down, the other can pick up the workload.
2. IBM Enterprise Storage Server Model 750—is a heavy-duty storage server that will be mirrored with the PCP terminal mentioned earlier.
3. Versa Tools' MTP T AV45 Transmitter and-Receiver—transmitters and receivers that provide a system for long-distance distribution of video and audio communications. To be used with CAT 5 Shielded Twisted Pair (STP).
   1. 117/L7 or M7 Signal Amplifier Tube—a tube that boosts a signal being sent over long distances.

Diagram A also illustrates the ARPS program sending bad code information to a virus patrol like antivirus vendors. This connection can be made through the use of Short Message Service and the Short Message Service Center. The idea is to install text and short messaging software and subscribe to a Short Messaging Service Center. What is being employed here it the concept of having a virus service center where bad code is sent and live updates are received.

An added precaution should be to have both the Remote Terminal and the IBM Storage Server mirror each other. The communications should be handled by a MTP T AV 45 transmitter and receiver combination package with CAT-5 cabling (to connect the network to the service center.) The transmitter and receiver are specially designed for long distance transmittals. Also connect an L-7 power amplifier to the CAT-5 cable to boost the signal being sent over the airwaves.

At this point there should be a fully loaded PCP terminal and a complete scanning system intact. The next step is to create and attach a Recording system. Here are the necessary components:
1. ASC's Voice-Over Internet Protocol (EVOip) telephony—a software transfer of speech and signaling information via a data network using Internet protocols. Can be used for communication between 2 PCs or a traditional phone and PC. *Though this software will be installed on the PCP terminal it is mentioned here because it records, monitors and logs all electronic communication and interaction of telephones, fax machines, e-mail transmittals, web chats and browsing and desktop computer activity.
2. Toshiba's Next Generation SurveiRix DVR—a digital video recording hardware device capable of recording at speeds of up to 480 pictures per second. (For every day use). (To be used in conjunction with IPTP image database)
3. Virtual Digital Audio Tape (VDAT)—a virtual audio digital recording device that allows the user to combine up to 16 real and virtual devices. (For every day use.) (Use in conjunction with DAT)
4. Digital Audio Tape (DAT)—a type of magnetic tape that uses a scheme called helical scan to record data. A DAT cartridge is slightly larger than a credit card in width and height and contains a magnetic tape that can hold from 2 to 24 gigabytes of data. It can support data transfer rates of about 2 MBps. Like other types of tapes, DATs are sequential-access media. The most common forma for DAT cartridges is digital data storage (DDS). For long-term backup and storage use.

The idea behind this recording setup is to have an internal watchtower at your fingertips. The EVOip software records every single transaction and interaction the entire network system performs. Used in conjunction with the Toshiba DVR (video recorder) and a VDAT (audio recorder) the EVOip recording setup can be an excellent source of documentation and surveillance. It is also extra help for the CIS department. It gives them a chance to get other things done i.e. (internal upgrades)!

See Diagram B Internal Recordings

Finally, the last few items needed to make this project work are:
1. Website—A group of related HTML documents and associated files, scripts, and databases that is served up by an HTTP server on the World Wide Web. The HTML documents in a Web site generally cover one or more related topics and are interconnected through hyperlinks. Most Web sites have a home page as their starting point, which frequently functions as a table of contents. Many large organizations such as corporations will have one or more HTTP servers dedicated to a single Web site. However, an HTTP server can also serve several small Web sites such as those owned by individuals. Users need a Web browser and an Internet connection to access a Web site.
2. Universal Resource Locator (URL)—an information resource that identifies other information resources, describes the information available in those resources and provides assistance in how to obtain the information.
3. Thumbnail Gallery Post (TGP)—a collection of miniature pictures uploaded to a website. TGP is written in PHP and uses a MySQL database to store all its data.
4. CGI—An external application that is executed by an HTTP server machine in response to a request by a client, like a Web browser. Generally, the CGI script is invoked when the user clicks on some element in a Web page, such as a link or an image. Communication between the CGI script and the server is carried out via the CGI specifications. CGI scripts can be written in many programming languages, including C, C++, and Visual Basic. However, the most commonly used language for CGI scripts is Perl because it is a small but robust language and it is common on UNIX, which is the platform on which the majority of Web sites run. CGI scripts don't necessarily need to be scripts; they can also be batch programs or compiled programs. CGI scripts are used to provide interactivity on a Web page, including such features as providing a form that users can fill out, image maps that contain links to other Web pages or resources, and links that users can click on to send e-mail to a specified address.
5. Network/PSC—software use to test, monitor and fix TCP problems in a network. (mirrored)

These will be used to create and post a website, graphics and other information. It will also be used to test and monitor TCP, respectively.

Live Routing is also an excellent defense mechanism for wireless communications. It's the same basic concept as described above except the scanning technology (Diagram A) is installed on “line-of-sight” infrared transmitters and receivers. An L-7/M-7 amplifier and baseband coax cable will be used in place of telephone lines and the transmitter/receiver will be installed on the roof of the buildings.

See Diagram C Live Routing & Wireless Communications

What is claimed is:

1. Live Routing will scan all incoming data packets checking them for intruder codes. It will then report the bad code to the “Virus patrol” (SMSC), display an alert and produce a document with the bad code information. Finally, Live Routing will delete the bad code and start the process over.

2. Live Routing will also produce an in-home watchtower where every communication and interaction performed inside and outside the network will be recorded both audio and visually. This includes telephone, website and chat room usage.

3. When used with wireless communications, Live Routing will monitor, scan and destroy intruder interference of radio signals sent by wireless communications. Cyber thieves will not be able to drive past a building using wireless technology and steal the information sent through radio signals.

4. Live Routing can send and receive phone calls through the computer system eliminating external phone systems.

5. Live Routing provides the necessary components to create and store company websites outside of the internal network.
